(19) United States
(12) Patent Application Publication
(10) Pub. No.: US 2026/0208345 A1
(43) Pub. Date: Jul. 23, 2026

(54) Tool Box and Tool Kit

(71) Applicant: Yantai Greenery Tools Co., Ltd., Yantai (CN)

(72) Inventors: Yongchao XIE, Yantai (CN); Xianglei ZHAO, Yantai (CN); Changlei FAN, Yantai (CN); Bo YU, Yantai, Shandong (CN)

(21) Appl. No.: 19/266,780

(22) Filed: Jul. 11, 2025

(30) Foreign Application Priority Data
Jan. 22, 2025 (CN) 202520148469.3

(51) Int. Cl. B25H 3/02

(52) U.S. Cl. CPC B25H 3/022

(57) ABSTRACT

A tool box and a tool kit are provided. The tool box includes a box body and a cover body. A first side surface and a second side surface of the box body are provided with communicated openings, the box body is provided with a control component, each control component is provided with a first suction component. The cover body covers the opening, and is provided with a second suction component. When the cover body covers the opening, the corresponding second suction component and first suction component are sucked. The cover body is rotationally connected to the box body, the rotational connection part between the cover body and the box body is provided with an elastic component. When the control component is pressed or pushed, the corresponding second suction component and first suction component are separated, the elastic component bounces the cover body to open the box body.

### CROSS-REFERENCE TO RELATED DISCLOSURES

This application claims priority to Chinese Patent Application No. 202520148469.3, filed on Jan. 22, 2025, which is incorporated herein by reference in its entirety.

### Technical Field

Embodiments of this disclosure relate to the technical field of containers for storing tools, in particular to a tool box and a tool kit.

### BACKGROUND

A tool box is a container for storing and carrying various tools, and is commonly used in various occasions such as household maintenance, electrical maintenance and electronic product maintenance.

In related technologies, the tool box usually includes a box body and a cover body for covering the box body. In a closed state of the tool box, the cover body is usually locked to the box body by a latch. During use, it is necessary to twist and open the latch and then flip open the cover body to open the box body. During fastening, it is necessary to cover the box body with the cover body and then fasten the latch.

However, there is a problem of inconvenient opening and closing of the tool box using the latch for locking the cover body and the box body.

### SUMMARY

Embodiments of this disclosure provide a tool box and a tool kit to solve a technical problem of inconvenient opening and closing of a tool box using a latch for locking a cover body and a box body.

The embodiments of this disclosure provide the following technical solutions to solve the above technical problem:

An embodiment of this disclosure provides a tool box, including a box body and a cover body, wherein
a first side surface and a second side surface of the box body are provided with communicated openings, the first side surface and the second side surface are two adjacent side surfaces of the box body, the box body is provided with at least one control component, each of the at least one control component is provided with a first suction component, and the first suction component is located at an edge of at least one of the openings;
the cover body covers the opening, the cover body is provided with a second suction component corresponding to the first suction component, and at least one of a corresponding second suction component and first suction component is a magnetic component; when the cover body covers the openings, the corresponding second suction component and first suction component are sucked;
the cover body is rotationally connected with the box body, and a rotational connection part between the cover body and the box body is provided with an elastic component; and the elastic component is configured in such a way that when the at least one control component is pressed or pushed, the corresponding second suction component and first suction component are separated, and the elastic component bounces the cover body to open the box body.

The embodiment of this disclosure has the following beneficial effects: the tool box provided in this embodiment of this disclosure includes the box body and the cover body for covering the box body, the box body is provided with the control component, and the control component is configured to control the opening and closing of the box body. When the tool box needs to be closed, the first suction component and the second suction component are sucked to enable the tool box to be in a closed state. When the tool box needs to be opened, the control component is pressed or pushed to enable a position of the first suction component arranged on the control component to change, the first suction component and the second suction component that are mutually sucked are separated (in this embodiment, misalignment also belongs to a type of separation), and a suction force between the first suction component and the second suction component is less than an elastic force of the elastic component, so that the elastic component bounces the cover body to open the box body. When the box body needs to be closed, it is only necessary to cover the opening with the cover body to suck the first suction component and the second suction component, so that the tool box is closed. In other words, for the tool box provided in this embodiment, the box body is automatically opened only by pressing or pushing the control component, and the tool box is automatically closed only by covering the opening with the cover body. The operations are simple and convenient, that is, the opening and closing operations of the tool box are convenient. In addition, the first side surface and the second side surface of the box body are provided with the communicated openings. This arrangement is able to enlarge the openings of the tool box, so that tools inside the tool box are more convenient to observe, take and place.

In a possible implementation, a mounting side surface of the box body is provided with a mounting groove, the at least one control component is rotationally mounted in the mounting groove, and the at least one control component is configured in such a way that when the control component is pressed, the first suction component and the second suction component are separated; and
the mounting side surface is adjacent to both the first side surface and the second side surface, or the mounting side surface is adjacent to the first side surface or the second side surface.

In a possible implementation, the mounting side surface includes an outer panel and a lining plate, the outer panel is located outside the lining plate, the outer panel is provided with a mounting port, and the mounting port is matched with the lining plate to form the mounting groove;
a first end of the at least one control component is rotationally connected to a side wall of the mounting groove, a second end of the at least one control component is provided with an extended protrusion, the extended protrusion extends from a space between the outer panel and the lining plate to the edge of the at least one of the openings and extends to an outer side of the outer panel, the extended protrusion is able to move between the outer panel and the lining plate, and the first end and the second end are two opposite ends of the at least one control component; and
the first suction component is arranged on a part of the extended protrusion extending out of the outer panel, and when the at least one control component close to the extended protrusion is pressed, the extended protrusion moves towards a direction close to the lining plate, and the first suction component and the second suction component are separated.

In a possible implementation, an elastic cushion is arranged between a bottom of the mounting groove and the at least one control component.

In a possible implementation, the elastic cushion is sponge.

In a possible implementation, two mounting side surfaces are provided and are respectively a third side surface and a fourth side surface of the box body, and the third side surface and the fourth side surface are two opposite side surfaces of the box body; and
the third side surface is adjacent to both the first side surface and the second side surface, the fourth side surface is adjacent to both the first side surface and the second side surface, and the two mounting side surfaces are both provided with the at least one control component.

In a possible implementation, the cover body includes a first cover plate for covering one opening, in the openings, on the first side surface and a second cover plate for covering one opening, in the openings, on the second side surface, the first cover plate and the second cover plate form an L-shaped structure, and the second cover plate is rotationally connected with the box body; and
the cover body is provided with a first tool placement position.

In a possible implementation, the first tool placement position includes a pry bar mounting position and/or a suction cup mounting position, the pry bar mounting position is arranged at a corner between the first cover plate and the second cover plate, and the suction cup mounting position is arranged on the second cover plate.

In a possible implementation, when the box body is opened, an included angle between the second cover plate and the second side surface is greater than or equal to 90° and less than or equal to 120°.

In a possible implementation, the second cover plate is provided with a connecting piece and two connecting columns configured to be connected with the connecting piece, wherein the two connecting columns are spaced apart, a gap is formed between the connecting piece and the second cover plate, and the two connecting columns are matched with the connecting piece to form the suction cup mounting position;
the connecting piece is provided with connecting lugs, the connecting lugs are rotationally connected with an inner side surface of the box body through a rotating shaft, and when the box body is opened, the connecting lugs are matched with the rotating shaft and an edge of the box body to define an opening angle of the cover body; and
the elastic component is a torsion spring, the torsion spring sleeves the rotating shaft, and an end of the torsion spring extending to the second cover plate extends into the gap.

In a possible implementation, the box body includes an outer side shell and a lining mounted in the outer side shell, and the lining is provided with a second tool placement position.

In a possible implementation, the tool box is of a cuboid structure; and
the lining has a third-stage step, wherein a vertical surface between a first-stage step and a second-stage step is provided with a row of first screw bit insertion positions, the second-stage step is provided with a screwdriver handle placement position, and the three-stage step is provided with a row of second screw bit insertion positions.

An embodiment of this disclosure further provides a tool kit. The tool kit includes the tool box according to any one of the above solutions and tools mounted in the tool box.

The beneficial effects of the tool kit provided in this embodiment of this disclosure are the same as the beneficial effects of the tool box mentioned above, and will not be repeated here.

In addition to the technical problem solved by this disclosure described above, the technical features constituting the technical solutions, and the beneficial effects brought by the technical features of these technical solutions, the other technical problems that are able to be solved by the tool box and the tool kit provided in this disclosure, other technical features included in the technical solutions, and the beneficial effects brought by these technical features will be further described in detail in specific implementations.

### BRIEF DESCRIPTION OF THE DRAWINGS

The accompanying drawings here are incorporated in the specification and constitute a part of the specification, illustrate the embodiments in accordance with this disclosure, and are used together with the specification to explain the principles of this disclosure.

FIG. 1 is a schematic view of a tool box according to an embodiment of this disclosure;

FIG. 2 is an exploded view of a tool box according to an embodiment of this disclosure;

FIG. 3 is a schematic view of a control component according to an embodiment of this disclosure;

FIG. 4 is a schematic view of a cover body according to an embodiment of this disclosure; and

FIG. 5 is a schematic view of a tool kit according to an embodiment of this disclosure.

### DESCRIPTION OF REFERENCE NUMERALS

100. box body;
110. opening; 120. control component; 130. third side surface; 140. fourth side surface; 150. elastic cushion; 160. outer side shell; 170. lining;
121. first end; 122. second end; 123. extended protrusion; 124. first suction component; 125. convex shaft;
191. first-stage step; 192. second-stage step; 193. third-stage step; 194. vertical surface; 195. first screw bit insertion position; 196. screwdriver handle placement position; 197. second screw bit insertion position;
131. outer panel; 132. lining plate; 133. mounting port;
200. cover body;
210. first cover plate; 220. second cover plate; 230. pry bar mounting position; 240. suction cup mounting position; 250. second suction component;
221. connecting piece; 222. connecting column; 223. gap; 224. connecting lug;
300. elastic component;
400. rotating shaft;
500. screw bit;
600. screwdriver handle;
700. pry bar;
800. suction cup.

Through the above accompanying drawings, the specific embodiments of this disclosure are shown and will be described in more detail later. These accompanying drawings and text descriptions are not intended to limit the conceptual scope of this disclosure in any way, but are intended to explain the concept of this disclosure for those skilled in the art by referring to specific embodiments.

### DETAILED DESCRIPTION OF THE EMBODIMENTS

The technical solutions in the embodiments of this disclosure are clearly and completely described below with reference to the accompanying drawings in the embodiments of this disclosure. It is apparent that the described embodiments are only a part of the embodiments of this disclosure, but are not all of the embodiments. All other embodiments obtained by those of ordinary skill in the art based on the embodiments in this disclosure without any creative effort shall fall within the scope of protection of this disclosure.

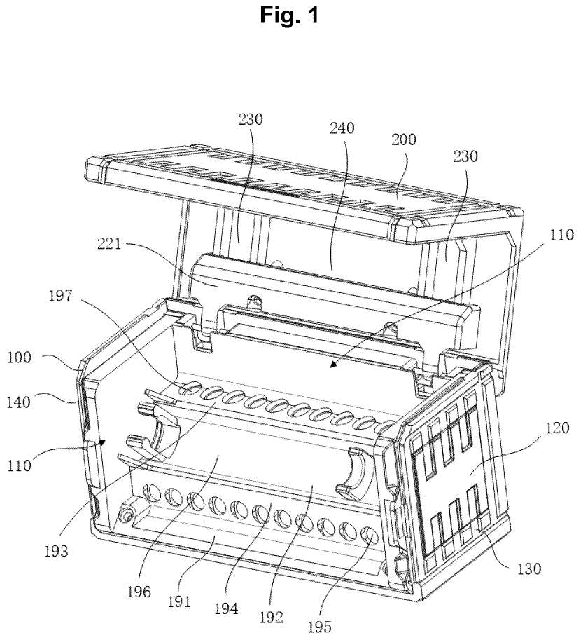

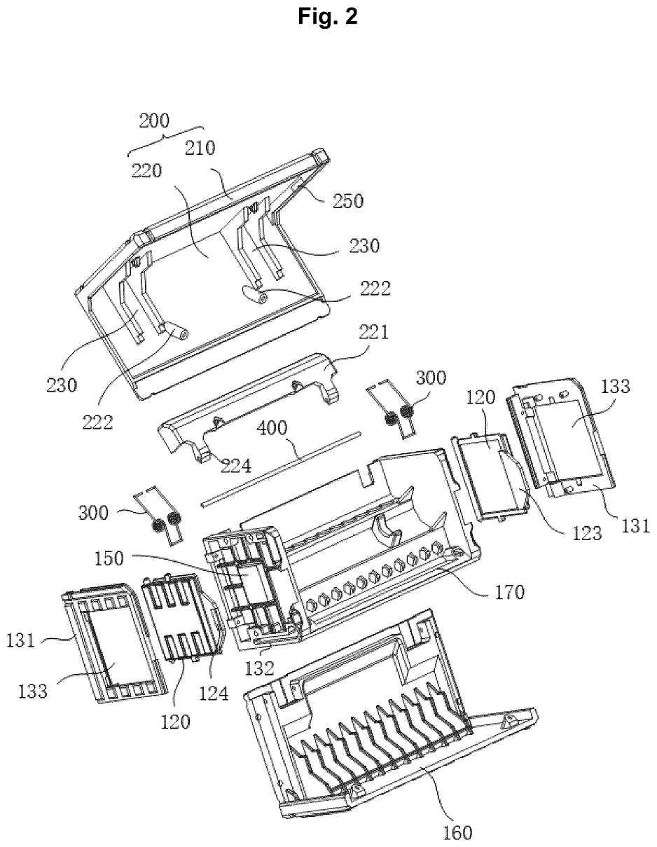

As shown in FIG. 1 and FIG. 2, a tool box provided in an embodiment of this disclosure includes a box body 100 and a cover body 200 for covering the box body 100. A first side surface and a second side surface of the box body 100 are provided with communicated openings 110, the first side surface and the second side surface are two adjacent side surfaces of the box body 100, the box body 100 is provided with at least one control component 120, each of the at least one control component 120 is provided with a first suction component 124, and the first suction component 124 is located at an edge of at least one of the openings 110. The cover body 200 covers the openings 110, the cover body 200 is provided with a second suction component 250 corresponding to the first suction component 124, and at least one of a corresponding second suction component 250 and first suction component 124 is a magnetic component. When the cover body 200 covers the openings 110, the corresponding second suction component 250 and first suction component 124 are sucked. Exemplarily, in the corresponding second suction component 250 and first suction component 124, one suction component is a magnet and the other is iron, or both suction components are magnets. When the cover body 200 covers the openings 110, the tool box is locked by a mutual suction of the first suction component 124 and the second suction component 250.

In this embodiment, the cover body 200 is rotationally connected with the box body 100, and a rotational connection part between the cover body 200 and the box body 100 is provided with an elastic component 300. The elastic component 300 is configured in such a way that when the at least one control component 120 is pressed or pushed, the corresponding second suction component 250 and first suction component 124 are separated, and the elastic component 300 bounces the cover body 200 to open the box body 100. In other words, the control component 120 is an operating component for opening the tool box. When the tool box needs to be closed, the first suction component 124 and the second suction component 250 are sucked to enable the tool box to be in a closed state. When the tool box needs to be opened, the control component 120 is pressed or pushed to enable a position of the first suction component 124 arranged on the control component 120 to change, the first suction component 124 and the second suction component 250 that are mutually sucked are separated, and a suction force between the first suction component 124 and the second suction component 250 is less than an elastic force of the elastic component 300, so that the elastic component 300 bounces the cover body 200 to open the box body 100. When the box body 100 needs to be closed, it is only necessary to cover the openings 110 with the cover body 200 to suck the first suction component 124 and the second suction component 250, so that the tool box is closed.

It should be noted that in this embodiment, misalignment also belongs to a type of separation, that is, a separation of the first suction component 124 and the second suction component 250 includes an separation of the first suction component 124 and the second suction component 250, a certain distance between the first suction component 124 and the second suction component 250, and a misalignment of the first suction component 124 and the second suction component 250.

For the tool box provided in this embodiment, the box body 100 is automatically opened only by pressing or pushing the control component 120, and the tool box is automatically closed only by covering the openings 110 with the cover body 200. The operations are simple and convenient, that is, the opening and closing operations of the tool box are convenient. In addition, the first side surface and the second side surface of the box body 100 are provided with the communicated openings 110. This arrangement is able to enlarge the openings 110 of the tool box, so that tools inside the tool box are more convenient to observe, take and place. During use, the second side surface of the box body 100 faces upwards, and the first side surface of the box body 100 faces forwards, that is, both the upper side and front side of the box body 100 have openings 110, Therefore, the openings 110 of the box body 100 is relatively large, which is better able to display each tool placed in the box body 100, and is convenient for a user to observe, find, take and place each tool.

Exemplarily, in some embodiments of this disclosure, a mounting side surface of the box body 100 is provided with a mounting groove, and the at least one control component 120 is rotationally mounted in the mounting groove. Exemplarily, the at least one control component 120 is rotationally mounted on a side wall of the mounting groove by convex shafts 125 at both ends. The control component 120 is configured in such a way that when the control component 120 is pressed, the first suction component 124 and the second suction component 250 are separated. The mounting side surface is adjacent to both the first side surface and the second side surface, or the mounting side surface is adjacent to the first side surface or the second side surface. In other words, the mounting side surface is adjacent to the openings 110, the control component 120 is mounted in the mounting groove of the mounting side surface, a part of the control component 120 extends to an edge of the openings 110, and the first suction component 124 is arranged on the control component 120 extending to the edge of the openings 110. When the control component 120 is pressed, the control component 120 rotates around an axial direction of the convex shaft 125, the position of the first suction component 124 arranged on the control component 120 changes with the control component 120, the first suction component 124 and the second suction component 250 that are mutually sucked are separated, and the elastic component 300 bounces the cover body 200 to open the box body 100. When the box body 100 needs to be closed, it is only necessary to cover the opening 110 with the cover body 200, the second suction component 250 sucks the first suction component 124, the control component 120 rotates around the axial direction of the convex shaft 125, and the first suction component 124 and the second suction component 250 are sucked, so that the tool box is closed.

Exemplarily, in order to reduce a collision between the control component 120 and a bottom of the mounting groove when the control component 120 is pressed, an elastic cushion 150 is arranged between the bottom of the mounting groove and the control component 120. Exemplarily, the elastic cushion 150 is sponge, a spring, an elastic sheet, or the like. When the elastic cushion 150 is sponge, the elastic cushion 150 is able to reduce the collision between the control component 120 and the bottom of the mounting groove when the control component 120 is pressed, and enable the control component 120 to be partially reset or completely reset to a certain extent. When the elastic cushion 150 is a spring or an elastic sheet, the elastic cushion 150 is able to reduce the collision between the control component 120 and the bottom of the mounting groove when the control component 120 is pressed, and enable the control component 120 to be completely reset. Therefore, when the cover body 200 is flipped to the openings 110 to cover the opening 110, the first suction component 124 is directly sucked with the second suction component 250.

In this embodiment, the elastic cushion 150 is sponge. Since a suction force still exists when the first suction component 124 is not in contact with the second suction component 250, when the elastic cushion 150 is sponge, even if the control component 120 cannot be reset, the second suction component 250 is also able to suck the first suction component 124 to enable the control component 120 to be reset. The cost of using the sponge is lower than the cost of using the spring or the elastic sheet, so that the overall cost of the tool box is able to be reduced.

Exemplarily, in order to facilitate an assembly of the tool box, the sponge is fixedly connected to the bottom of the mounting groove.

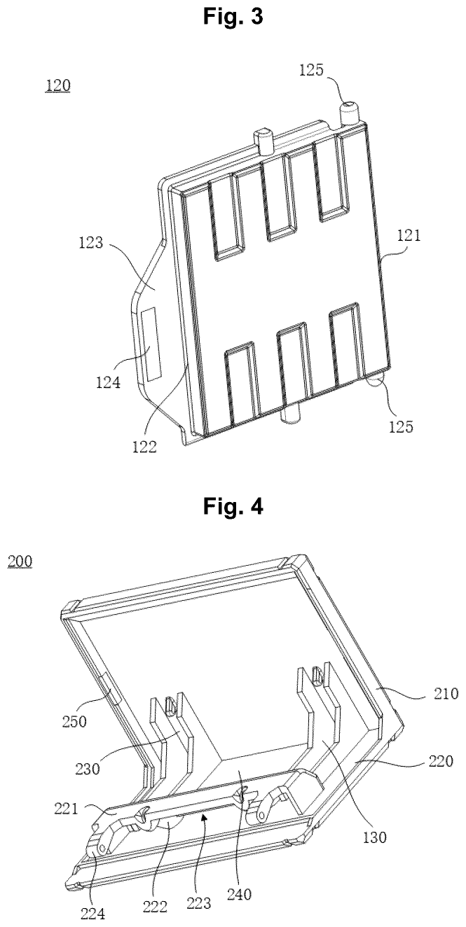

As shown in FIG. 2 and FIG. 3, in some embodiments of this disclosure, the mounting side surface includes an outer panel 131 and a lining plate 132, the outer panel 131 is located outside the lining plate 132, the outer panel 131 is provided with a mounting port 133, and the mounting port 133 is matched with the lining plate 132 to form the mounting groove. In other words, a part of the lining plate 132 corresponding to the mounting port 133, that is, the part of the lining plate 132 located in the mounting port 133, is the bottom of the mounting groove, a side wall of the mounting port 133 is the side wall of the mounting groove, and the elastic cushion 150 is arranged between the lining plate 132 and the control component 120.

A first end 121 of the control component 120 is rotationally connected to the side wall of the mounting groove, a second end 122 of the control component 120 is provided with an extended protrusion 123, the extended protrusion 123 extends from a space between the outer panel 131 and the lining plate 132 to the edge of the openings 110 and extends to an outer side of the outer panel 131, the extended protrusion 123 is able to move between the outer panel 131 and the lining plate 132, and the first end 121 and the second end 122 are two opposite ends of the control component 120. In other words, a moving space for the extended protrusion 123 to move back and forth along a first direction is formed between the outer panel 131 located at the second end 122 of the control component 120 and the lining plate 132, and the extended protrusion 123 extends from the space between the outer panel 131 and the lining plate 132 to the outer side of the outer panel 131 and is exposed to the outer side of the outer panel 131, wherein the first direction is a rotation direction of the control component 120 around the convex shaft 125. The first suction component 124 is arranged on the part of the extended protrusion 123 extending out of the outer panel 131, and when the control component 120 close to the extended protrusion 123 is pressed, the extended protrusion 123 moves towards a direction close to the lining plate 132, and the first suction component 124 and the second suction component 250 are separated. In other words, the cover body 200 covers the outer side of the extended protrusion 123, and when the control component 120 is pressed inwards, the extended protrusion 123 moves inwards accordingly, so that the first suction component 124 and the second suction component 250 are separated. The operating way of pressing the control component 120 inwards is convenient for a user to operate, and the arrangement of the outer panel 131 and the lining plate 132 facilitates the assembly of the box body 100.

In some embodiments of this disclosure, in order to facilitate the opening operation of the tool box and ensure more secure suction between the cover body 200 and the box body 100 when the tool box is closed, as shown in FIG. 2, two mounting side surfaces are provided and are respectively a third side surface 130 and a fourth side surface 140 of the box body 100, and the third side surface 130 and the fourth side surface 140 are two opposite side surfaces of the box body 100, wherein the third side surface 130 is adjacent to both the first side surface and the second side surface, the fourth side surface 140 is adjacent to both the first side surface and the second side surface, and the two mounting side surfaces are both provided with the control components 120. In other words, the third side surface 130 and the fourth side surface 140 are two side surfaces located on both sides of the openings 110 in a second direction, and the second direction is an axial direction in which the box body 100 is rotationally connected with the cover body 200. The control components 120 are arranged on two opposite side surfaces of the box body 100. When the tool box needs to be opened, a user is able to pinch the two side surfaces provided with the control components 120 of the tool box with the thumb and index finger and forcibly press to open the tool box. Therefore, the tool box is able to be opened with one hand, and the operation is simple and convenient.

As shown in FIG. 2 and FIG. 4, the cover body 200 includes a first cover plate 210 for covering the opening 110 on the first side surface and a second cover plate 220 for covering the opening 110 on the second side surface, the first cover plate 210 and the second cover plate 220 form an L-shaped structure, and the second cover plate 220 is rotationally connected with the box body 100. The cover body 200 is provided with a first tool placement position. The tool box of this embodiment fully utilizes the space of the cover body 200. The cover body 200 is provided with the first tool placement position for placing tools, so that the tool box is able to store more tools.

Exemplarily, the first tool placement position includes a pry bar mounting position 230 and/or a suction cup mounting position 240, the pry bar mounting position 230 is arranged at a corner between the first cover plate 210 and the second cover plate 220, and the suction cup mounting position 240 is arranged on the second cover plate 220.

As shown in FIG. 1, when the box body 100 is opened, an included angle between the second cover plate 220 and the second side surface is greater than or equal to 90° and less than or equal to 120°. In other words, when the box body 100 is opened, the included angle between the second cover plate 220 and the surface of the opening 110 corresponding to the second cover plate 220 ranges from 90° to 120°. Exemplarily, the included angle is 90°, 100°, 110°, 120°, or the like. This arrangement ensures that the box body 100 is opened, and simultaneously, the cover body 200 is located at the upper part of the box body 100. In this way, when the tool box is opened and placed on a workbench, the tool box occupies a relatively small area of the workbench, and the occupied area is an area of the workbench when the tool box is in a closed state, thereby better saving the space for a crowded workbench. Compared to the situation in related technologies where the box body 100 and the cover body 200 of the tool box are laid flat on the workbench when the tool box is opened, the tool box provided in this embodiment saves half of a desktop area occupation. Moreover, for the tool box in related technologies where the box body 100 and the cover body 200 are laid flat on the workbench when the tool box is opened, the desktop area occupied when the tool box is opened is twice that of the desktop area occupied when the tool box is in a closed state, so the desktop area occupied is relatively large. Thus, when the tool box and the tool kit need to be opened and used, it may be necessary to move or push other objects on the desktop, there are problems of position change and inconvenient search of other objects due to position movement, and there is also a risk that other objects are pushed off the desktop due to position movement. The tool box of this embodiment only needs to be opened and then placed in the original position, so that the use is convenient.

As shown in FIG. 2 and FIG. 4, the second cover plate 220 is provided with a connecting piece 221 and two connecting columns 222 that are spaced apart configured to be connected with the connecting piece 221, a gap 223 is formed between the connecting piece 221 and the second cover plate 220, and the two connecting columns 222 are matched with the connecting piece 221 to form the suction cup mounting position 240. The connecting piece 221 is provided with connecting lugs 224, and the connecting lugs 224 are rotationally connected with an inner side surface of the box body 100 through a rotating shaft 400. When the box body 100 is opened, the connecting lugs 224 are matched with the rotating shaft 400 and an edge of the box body 100 to define an opening angle of the cover body 200. In addition, in this embodiment, the elastic component 300 is a torsion spring, the torsion spring sleeves the rotating shaft 400, and an end of the torsion spring extending to the second cover plate 220 extends into the gap 223. In other words, the connecting piece 221 plays a role in cooperating with the second cover plate 220 to form the suction cup mounting position 240, plays a role in providing the connecting lugs 224 rotationally connected with the box body 100 to define the opening angle of the cover body 200, and also plays a role in hiding a tail end of the torsion spring to enable the box body 100 to be more aesthetic.

As shown in FIG. 1, in some embodiments of this disclosure, the box body 100 includes an outer side shell 160 and a lining 170 mounted in the outer side shell 160, and the lining 170 is provided with a second tool placement position. By the arrangement of the lining 170, the tool box of this embodiment is more flexible and versatile, and the types of tools stored in the tool box are able to be changed by replacing the lining 170. In addition, the lining plates 132 mentioned above are side plates of the lining 170 on both sides of the openings 110, that is, the arrangement of the lining 170 facilitates the assembly of the tool box.

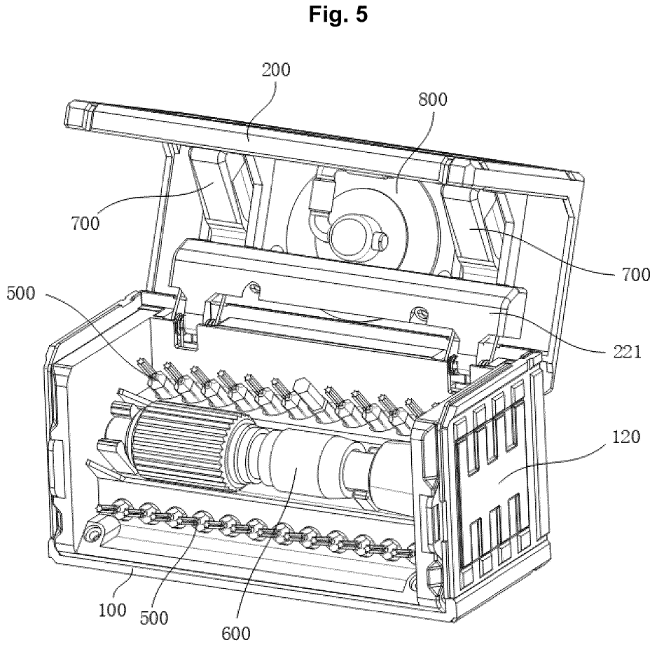

Exemplarily, as shown in FIG. 1 and FIG. 5, the tool box is of a cuboid structure. The lining 170 has a third-stage step 193, wherein a vertical surface 194 between a first-stage step 191 and a second-stage step 192 is provided with a row of first screw bit insertion positions 195, and the first screw bit insertion positions 195 are used for insertion of screw bits 500; the second-stage step 192 is provided with a screwdriver handle placement position 196, and the screwdriver handle placement position 196 is used for placement of a screwdriver handle 600; and the three-stage step 193 is provided with a row of second screw bit insertion positions 197, and the second screw bit insertion positions 197 are used for insertion of screw bits 500. In other words, the second tool placement position arranged on the lining 170 includes the screwdriver handle placement position 196 and screw bit insertion positions, the lining 170 is provided with the screwdriver handle placement position 196 in a middle of a vertical direction, and upper and lower sides of the screwdriver handle placement position 196 are provided with screw bit placement positions. By this arrangement, a distribution of tools in the tool box is reasonable and aesthetic, and an internal space of the tool box is fully utilized to arrange more tools.

As shown in FIG. 5, an embodiment of this disclosure further provides a tool kit. The tool kit includes the tool box according to any of the above solutions, and tools mounted in the tool box, wherein the tool may be a screwdriver handle 600, a screw bit 500, a pry bar 700, a suction cup 800, or the like.

Those skilled in the art will easily come up with other implementation solutions of this disclosure after considering the specification and practicing the invention disclosed herein. This disclosure is intended to cover any variations, uses, or adaptive changes of this disclosure. These variations, uses, or adaptive changes follow the general principles of this disclosure and include common general knowledge or common technical means in the art, which are not disclosed in this disclosure. The specification and embodiments are only considered as exemplary, and the true scope and spirit of this disclosure are indicated by the following claims.

It should be understood that this disclosure is not limited to the precise structure described above and shown in the accompanying drawings, and various modifications and changes can be made without departing from the scope thereof. The scope of this disclosure is limited only by the appended claims.

1. A tool box, comprising a box body and a cover body;
a first side surface and a second side surface of the box body are provided with communicated openings, the first side surface and the second side surface are two adjacent side surfaces of the box body, the box body is provided with at least one control component, each of the at least one control component is provided with a first suction component, and the first suction component is located at an edge of at least one of the openings;
the cover body covers the openings, the cover body is provided with a second suction component corresponding to the first suction component, and at least one of a corresponding second suction component and first suction component is a magnetic component; when the cover body covers the openings, the corresponding second suction component and first suction component are sucked; the cover body is rotationally connected with the box body, and a rotational connection part between the cover body and the box body is provided with an elastic component; and the elastic component is configured in such a way that when the at least one control component is pressed or pushed, the corresponding second suction component and first suction component are separated, and the elastic component bounces the cover body to open the box body.

2. The tool box according to claim 1, wherein a mounting side surface of the box body is provided with a mounting groove, the at least one control component is rotationally mounted in the mounting groove, and the at least one control component is configured in such a way that when the control component is pressed, the first suction component and the second suction component are separated; and
the mounting side surface is adjacent to both the first side surface and the second side surface, or the mounting side surface is adjacent to the first side surface or the second side surface.

3. The tool box according to claim 2, wherein the mounting side surface comprises
an outer panel and a lining plate, the outer panel is located outside the lining plate, the outer panel is provided with a mounting port, and the mounting port is matched with the lining plate to form the mounting groove;
a first end of the at least one control component is rotationally connected to a side wall of the mounting groove, a second end of the at least one control component is provided with an extended protrusion, the extended protrusion extends from a space between the outer panel and the lining plate to the edge of the at least one of the openings and extends to an outer side of the outer panel, the extended protrusion is able to move between the outer panel and the lining plate, and the first end and the second end are two opposite ends of the at least one control component; and
the first suction component is arranged on a part of the extended protrusion extending out of the outer panel, and when the at least one control component close to the extended protrusion is pressed, the extended protrusion moves towards a direction close to the lining plate, and the first suction component and the second suction component are separated.

4. The tool box according to claim 2, wherein an elastic cushion is arranged between a bottom of the mounting groove and the at least one control component.

5. The tool box according to claim 4, wherein the elastic cushion is sponge.

6. The tool box according to claim 2, wherein two mounting side surfaces are
provided and are respectively a third side surface and a fourth side surface of the box body, and the third side surface and the fourth side surface are two opposite side surfaces of the box body; and
the third side surface is adjacent to both the first side surface and the second side surface, the fourth side surface is adjacent to both the first side surface and the second side surface, and the two mounting side surfaces are both provided with the at least one control component.

7. The tool box according to claim 6, wherein the mounting side surface comprises an outer panel and a lining plate, the outer panel is located outside the lining plate, the outer panel is provided with a mounting port, and the mounting port is matched with the lining plate to form the mounting groove;
a first end of the at least one control component is rotationally connected to a side wall of the mounting groove, a second end of the at least one control component is provided with an extended protrusion, the extended protrusion extends from a space between the outer panel and the lining plate to the edge of the at least one of the openings and extends to an outer side of the outer panel, the extended protrusion is able to move between the outer panel and the lining plate, and the first end and the second end are two opposite ends of the at least one control component; and
the first suction component is arranged on a part of the extended protrusion extending out of the outer panel, and when the at least one control component close to the extended protrusion is pressed, the extended protrusion moves towards a direction close to the lining plate, and the first suction component and the second suction component are separated.

8. The tool box according to claim 6, wherein an elastic cushion is arranged between a bottom of the mounting groove and the at least one control component.

9. The tool box according to claim 8, wherein the elastic cushion is sponge.

10. The tool box according to claim 1, wherein the cover body comprises a first cover plate for covering one opening, in the openings, on the first side surface and a second cover plate for covering one opening, in the openings, on the second side surface, the first cover plate and the second cover plate form an L-shaped structure, and the second cover plate is rotationally connected with the box body; and
the cover body is provided with a first tool placement position.

11. The tool box according to claim 10, wherein the first tool placement position comprises a pry bar mounting position, the pry bar mounting position is arranged at a corner between the first cover plate and the second cover plate.

12. The tool box according to claim 10, wherein the first tool placement position comprises a suction cup mounting position, the suction cup mounting position is arranged on the second cover plate.

13. The tool box according to claim 10, wherein the first tool placement position comprises a pry bar mounting position and a suction cup mounting position, the pry bar mounting position is arranged at a corner between the first cover plate and the second cover plate, and the suction cup mounting position is arranged on the second cover plate.

14. The tool box according to claim 10, wherein when the box body is opened, an included angle between the second cover plate and the second side surface is greater than or equal to 90° and less than or equal to 120°.

15. The tool box according to claim 14, wherein the second cover plate is provided with a connecting piece and two connecting columns configured to be connected with the connecting piece, wherein the two connecting columns are spaced apart, a gap is formed between the connecting piece and the second cover plate, and the two connecting columns are matched with the connecting piece to form the suction cup mounting position;
the connecting piece is provided with connecting lugs, the connecting lugs are rotationally connected with an inner side surface of the box body through a rotating shaft, and when the box body is opened, the connecting lugs are matched with the rotating shaft and an edge of the box body to define an opening angle of the cover body; and
the elastic component is a torsion spring, the torsion spring sleeves the rotating shaft, and an end of the torsion spring extending to the second cover plate extends into the gap.

16. The tool box according to claim 10, wherein a mounting side surface of the box
body is provided with a mounting groove, the at least one control component is rotationally mounted in the mounting groove, and the at least one control component is configured in such a way that when the control component is pressed, the first suction component and the second suction component are separated; and
the mounting side surface is adjacent to both the first side surface and the second side surface, or the mounting side surface is adjacent to the first side surface or the second side surface.

17. The tool box according to claim 16, wherein the mounting side surface comprises
an outer panel and a lining plate, the outer panel is located outside the lining plate, the outer panel is provided with a mounting port, and the mounting port is matched with the lining plate to form the mounting groove;
a first end of the at least one control component is rotationally connected to a side wall of the mounting groove, a second end of the at least one control component is provided with an extended protrusion, the extended protrusion extends from a space between the outer panel and the lining plate to the edge of the at least one of the openings and extends to an outer side of the outer panel, the extended protrusion is able to move between the outer panel and the lining plate, and the first end and the second end are two opposite ends of the at least one control component; and
the first suction component is arranged on a part of the extended protrusion extending out of the outer panel, and when the at least one control component close to the extended protrusion is pressed, the extended protrusion moves towards a direction close to the lining plate, and the first suction component and the second suction component are separated.

18. The tool box according to claim 1, wherein the box body comprises an outer side shell and a lining mounted in the outer side shell, and the lining is provided with a second tool placement position.

19. The tool box according to claim 18, wherein the tool box is of a cuboid structure; and
the lining has a third-stage step, wherein a vertical surface between a first-stage step and a second-stage step is provided with a row of first screw bit insertion positions, the second-stage step is provided with a screwdriver handle placement position, and the three-stage step is provided with a row of second screw bit insertion positions.

20. A tool kit, comprising the tool box according to claim 1 and tools mounted in the tool box.
